(19) United States
(12) Patent Application Publication
(10) Pub. No.: US 2019/0135238 A1
(43) Pub. Date: May 9, 2019

(54) VEHICLE PROVIDED WITH AT LEAST TWO WINDSCREEN WIPER DEVICES OF THE FLAT BLADE TYPE

(71) Applicant: FEDERAL-MOGUL S.A., AUBANGE (BE)

(72) Inventor: GUILLAUME SEILLER, RIBEAUVILLE (FR)

(21) Appl. No.: 16/095,796

(22) PCT Filed: May 2, 2016
(86) PCT No.: PCT/EP2016/059771

§ 371 Date: Oct. 23, 2018

(51) Int. Cl. B60S 1/40

(52) U.S. Cl. CPC B60S 1/4087

(57) ABSTRACT

A vehicle provided with at least two windscreen wiper devices (1) of the flat blade type each comprising an elastic, elongated carrier element, as well as an elongated wiper blade (2) of a flexible material, which can be placed in abutment with a windscreen of the vehicle to be wiped, each wiper blade (2) including at least one groove (3), in which groove (3) a longitudinal strip (4) of the carrier element is disposed, which windscreen wiper devices (1) each comprise a connecting device (6) for a respective oscillating arm (7), wherein each oscillating arm (7) is pivotally connected to its corresponding connecting device (6) about a pivot axis near one end, wherein each connecting device (6) comprises at least two parts (8, 9) provided with protrusion/hole means arranged for connecting said parts (8, 9) together through a snapping operation, wherein the first part (8) is retained onto its corresponding wiper blade (2) and wherein the second part (9) comprises a channel arranged for inserting a rod-like extension of its corresponding oscillating arm (7) therein, and wherein each second part (9) and said extension of its corresponding oscillating arm (7) comprise mutually cooperating protuberance/groove means resulting in an asymmetric form of said second part (9) and of said extension of said oscillating arm (7) with respect to their middle longitudinal planes, seen in vertical direction, in order to ensure that each windscreen wiper device (1) can only be mounted on its corresponding oscillating arm (7).

### BACKGROUND

### 1. Technical Field

The present invention relates to a vehicle provided with at least two windscreen wiper devices of the flat blade type each comprising an elastic, elongated carrier element, as well as an elongated wiper blade of a flexible material, which can be placed in abutment with a windscreen of the vehicle to be wiped, each wiper blade including at least one groove, in which groove a longitudinal strip of the carrier element is disposed, which windscreen wiper devices each comprise a connecting device for a respective oscillating arm, wherein each oscillating arm is pivotally connected to its corresponding connecting device about a pivot axis near one end.

Particularly, the wiper blade comprises a spoiler at a side thereof facing away from the windscreen to be wiped, wherein the wiper blade and the spoiler are preferably made in one piece through extrusion. The longitudinal groove is preferably a central longitudinal groove accommodating the longitudinal strip. The longitudinal strip is also called a “flexor”, while the connecting device is also indicated as a “connector”.

Such a vehicle with two windscreen wiper devices is generally known. This prior art windscreen wiper device is designed as a “yokeless” wiper device or “flat blade”, wherein no use is made of several yokes pivotally connected to each other, but wherein the wiper blade is biased by the carrier element, as a result of which it exhibits a specific curvature.

Such a known vehicle is often equipped with a so-called “tandem” wiper arrangement on the front side thereof. In the latter case the wiper blades on the driver's side and passenger's side may mutually differ as far as their length and/or the curvature of the carrier element (that is the longitudinal strips or “flexors”) is concerned. In the latter case a reverse mounting of both blades would then result in a situation, wherein the wiper blade on the driver's side is pressed too much on the windscreen to be wiped and the wiper blade on the passenger's side is pressed too little on the windscreen to be wiped, or vice versa. Such a situation is of course undesirable, as the wiping qualities would then be seriously affected.

In such arrangement two oscillating arms are each pivotally connected to a mounting head fixed for rotation to a shaft driven by a small motor, wherein in use the one shaft rotates alternately in a counterclockwise and in a clockwise sense (this shaft corresponds to the oscillating arm at the driver's side of the vehicle), whereas the other shaft simultaneously rotates in the same sense (this shaft corresponds to the oscillating arm at the passenger's side of the vehicle). In use both shafts carry the mounting heads into rotation also, which in turn draw the oscillating arms into rotation and by means of the connecting devices move the wiper blades accordingly. In practice it has become apparent that, during replacement of windscreen wiper devices used in a vehicle with the above-described “tandem” wiper arrangement, such a windscreen wiper device meant to be mounted on the oscillating arm at the driver's side of the vehicle is actually mounted on the oscillating arm at the passenger's side of the vehicle, while such a windscreen wiper device meant to be mounted on the oscillating arm at the passenger side of the vehicle is actually mounted on the oscillating arm at the driver's side of the vehicle. Particularly such a reversed mounting results in that the curvature and the length of the wiper blade do not match, so that the mounting seriously affects the wiping qualities thereof particularly at high speeds, with all negative consequences involved.

### SUMMARY

The object of the invention is to provide a vehicle, particularly an automobile, with a windscreen wiper device of the “yokeless blade” type having a spoiler (or “air-deflector”), wherein it is no longer possible to mount a windscreen wiper device meant for the oscillating arm at the passenger side of the automobile on the oscillating arm at the driver's side of the automobile, and vice versa (that is to mount a windscreen wiper device meant for the oscillating arm at the driver's side of the automobile on the oscillating arm at the passenger's side of the automobile).

In order to accomplish that objective, a vehicle of the type referred to in the introduction is characterized according to the invention in that each connecting device comprises at least two parts provided with protrusion/hole means arranged for connecting the parts together through a snapping operation, wherein the first part is retained onto its corresponding wiper blade and wherein the second part comprises a channel arranged for inserting a rod-like extension of its corresponding oscillating arm therein, and wherein each second part and the extension of its corresponding oscillating arm comprise mutually cooperating protuberance/groove means resulting in an asymmetric form of the second part and of the extension of the oscillating arm with respect to their middle longitudinal planes, seen in vertical direction, in order to ensure that each windscreen wiper device can only be mounted on its corresponding oscillating arm. In other words, due to the asymmetric form of both the second part and its corresponding oscillating arm, it is prevented that the windscreen wiper device meant for the oscillating arm at the passenger side of the automobile can be mounted on the oscillating arm at the driver's side of the automobile, and that the windscreen wiper device meant for the oscillating arm at the driver's side of the automobile can be mounted on the oscillating arm at the passenger's side of the automobile. By avoiding any such reverse mounting of these windscreen wiper devices and thus by mounting them in the right position, the wiping qualities will be guaranteed at all times.

The first and second part are preferably detachably interconnected with the help of the protrusion/hole means.

In the framework of the present invention the first part and the second part of the connecting device are each preferably made in one piece of plastic.

Further, it is noted that the present invention is not restricted to the use of only one longitudinal strip that is particularly located in a central, channel forming groove of the wiper blade. Instead, the carrier element may comprise two, spaced-apart longitudinal strips forming the elastic, elongated carrier element, wherein the strips are disposed in opposing longitudinal grooves on longitudinal sides of the wiper blade. In the latter case the first part of the connecting device may welded, soldered, brazed or glued to the longitudinal strips. In the former case, the first part of the connecting device may be welded, soldered, brazed or glued to an elastomeric material, such as rubber, of the wiper blade.

In a preferred embodiment of a vehicle in accordance with the invention the extension is provided with a protuberance cooperating with a groove of the channel.

In another preferred embodiment of a vehicle according to the invention the channel and the extension each have a rectangular cross-section. Particularly, the protuberance extends upwardly from an upper surface of the extension, and wherein the groove extends in an upper wall of the channel. In the alternative, the protuberance extends downwardly from a bottom surface of the extension, and wherein the groove extends in a lower wall of the channel. In the alternative, the protuberance extends sideward from a side surface of the extension, and wherein the groove extends in a sidewall of the channel.

In another preferred embodiment of a vehicle in accordance with the invention each windscreen wiper device is provided with retaining means arranged for retaining the connecting device onto the extension of its corresponding oscillating arm, wherein the retaining means comprises at least one downwardly extending protrusion on the second part, wherein the protrusion is movable between an inward position, wherein in mounted position the protrusion engages into a correspondingly shaped hole provided in the extension of the oscillating arm and the connecting device is retained onto the oscillating arm, and an outward position, wherein in dismounted position the protrusion disengages from the hole provided in the extension of the oscillating arm and the connecting device is released from the oscillating arm. Particularly, upon activating a push button on the second part the protrusion is hingeable from the inward position and the outward position along hinges of the second part located on opposite sides of the extension of the oscillating arm in mounted position thereof. Such a push button can be pressed in by hand. More in particular, a part of a top wall of the second part containing the downwardly extending protrusion is allowed to hinge about a hinge upon activating or deactivating (particularly using a finger) the push button on the part of the top wall. Even more in particular, the part of the top wall comprises at a bottom side thereof the downwardly extending protrusion, as well as at a top side thereof the push button. By activating or deactivating the push button, a hinge movement or “seesaw movement” is realized. The protrusion and the push button are preferably located at opposite ends of the part of the top wall of the second part.

In another preferred embodiment of a vehicle according to the invention the retaining means form first retaining means, wherein each windscreen wiper device further comprises second retaining means arranged for retaining the connecting device onto the extension of its corresponding oscillating arm, wherein the second retaining means comprises at least one protrusion provided on the first part arranged to engage into a recess provided along a longitudinal side of the extension of the oscillating arm. In the alternative, the protrusion on the first part is arranged to engage into a hole having a closed circumference provided in the oscillating arm. Preferably, the protrusion on the first part is located near an insertion opening of the channel arranged for inserting the oscillating arm therein. In other words, the recess provided on a longitudinal side of the oscillating arm is located at a larger distance to the free end of the oscillating arm than the hole in the oscillating arm cooperating with the protrusion on the second part. Accordingly, mounting or dismounting the connecting device onto or from the oscillating arm can be effected at a certain pivot angle of the oscillating arm relative to the first part. The present invention also relates to a windscreen wiper device as defined in a vehicle in accordance with the invention.

The present invention also refers to an oscillating arm as defined in a vehicle according to the invention.

### THE DRAWINGS

The invention will now be explained in more detail with reference to figures illustrated in a drawing, wherein

FIG. 1 is a schematic and perspective view/partly in exploded view, of a main part of a windscreen wiper device and an oscillating arm according to the invention, wherein a first part and a second part of a connecting device of the windscreen wiper device is shown arranged to be connected to the oscillating arm;

FIG. 2 are side views of the oscillating arm inserted inside the second part of the connecting device of FIG. 1;

FIG. 3 corresponds to FIG. 2, but now showing schematic, perspective views;

FIG. 4 is a top view of FIG. 3;

FIG. 5 are cross-sectional views along the line A-A of FIG. 4;

FIG. 6 are schematic, perspective views of (a part of) the first part of the connector, as well as a view form below of the connector connected to the oscillating arm;

FIG. 7 shows successive steps for fitting together the connecting device and the oscillating arm according to the invention;

FIG. 8 shows a perspective view and a top view of the oscillating arm according to the invention; and

FIG. 9 is a schematic, perspective view of an extremity of the oscillating arm and of the second part.

### DETAILED DESCRIPTION

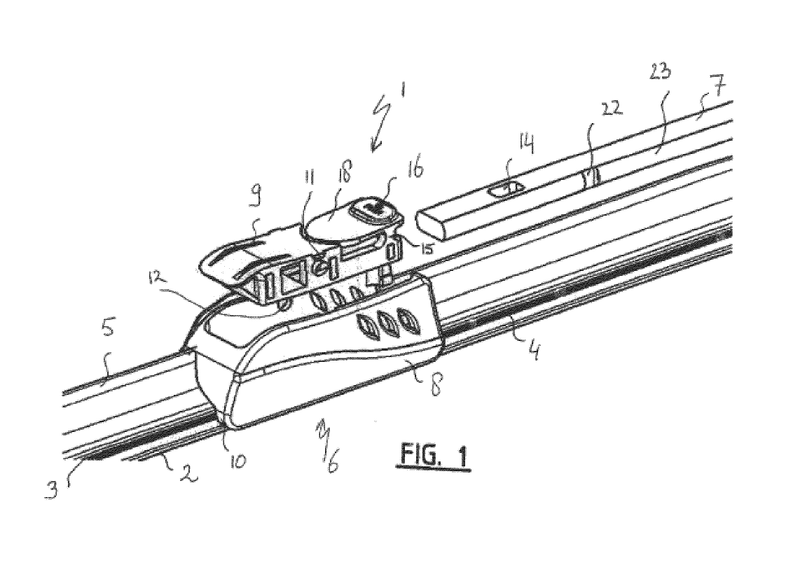

FIG. 1 shows a windscreen wiper device 1 of the “flat blade” type according to the invention. The windscreen wiper device 1 is built up of an elastomeric wiper blade 2, in the longitudinal sides of which opposing longitudinal grooves 3 are formed, and of longitudinal strips 4 made of spring band steel, which are fitted in the longitudinal grooves 3. the strips 4 form a flexible carrier element for the rubber wiper blade 2, as it were, which is thus biased in a curved position (the curvature in operative position being that of a windscreen to be wiped). Neighbouring ends of strips 4 are interconnected on either side of the windscreen wiper device 1 by means of connecting pieces (not shown) functioning as clamping members. In this embodiment, the connecting pieces may be separate constructional elements, which may be form-locked (“positive locking” or “having positive fit”), as well as force-locked to the ends of strips 4. In another preferred variant, the connecting pieces are in one piece with the strips 4 made of spring band steel. In the latter case the connecting pieces form transverse bridges for the strips 4, as it were. Possibly, a spoiler 5 is furthermore provided.

The windscreen wiper device 1 is furthermore built up of a connecting device 6 of plastic material for an oscillating wiper arm 7, the wiper arm 7 is finalized by an extension (without an adapter). Connecting device 6 consists of a first part 8 and a second part 9 detachably connected together. The first part 8 is retained onto the wiper blade 2, whereas the second part 9 is positioned within the first part 8, that is between parallel, upright walls thereof. Further, the first part 8 comprises clamping members 10 that are integral therewith, which engage round longitudinal sides of the strips 4 that face away from each other, as a result of which the connecting device 6 is firmly attached to the unit consisting of wiper blade 2 and strips 4. The second part 9 has a shaped cross-section at the location of its connection to the first part 8 The oscillating wiper arm 7 is pivotally connected to the connecting device 6 about a pivot axis near a free end thereof, and that in the following manner.

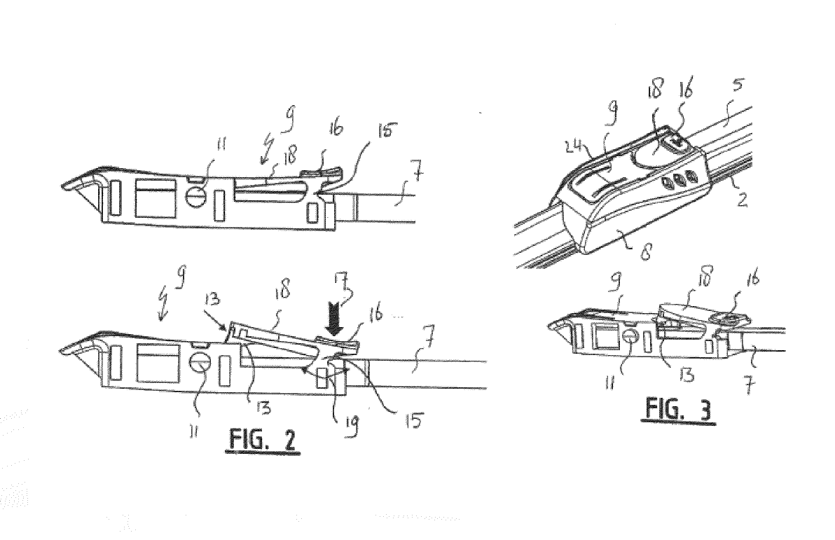

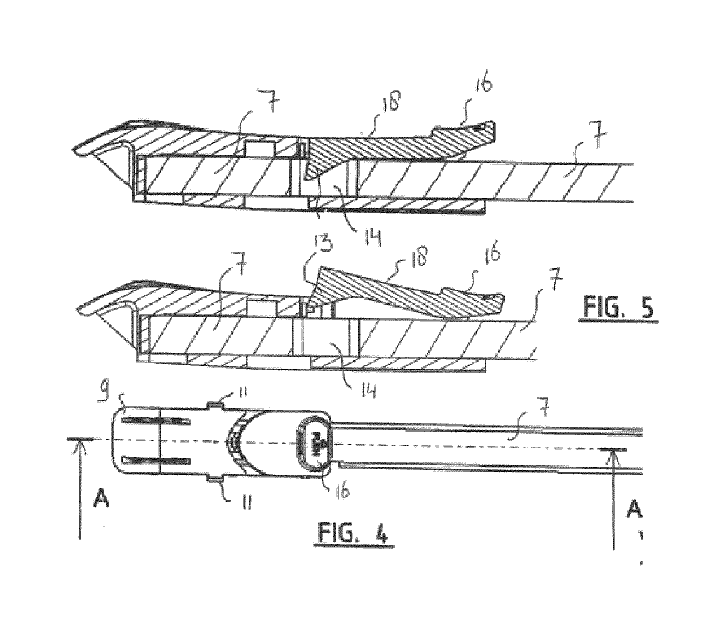

With reference to FIGS. 1 and 2, the second part 9 comprises two cylindrical protrusions 11 (only one is visible) extending outwards on either side of the second part 9, that is on each vertical side wall of its U-shaped, rectangular or square cross-section. These protrusions 11 pivotally engage in identically shaped cylindrical holes 12 (only one thereof is visible in FIGS. 1 and 2) of the first part 8. The protrusions 11 act as bearing surfaces at the location of a pivot axis in order to pivot the second part 9 (and the oscillating wiper arm 7 attached thereto) about the pivot axis near a free end of the arm 7. The protrusions 11 are preferably in one piece with the second part 9. In the alternative, the protrusions 11 are part of a single pivot pin perpendicular to the connecting device 6.

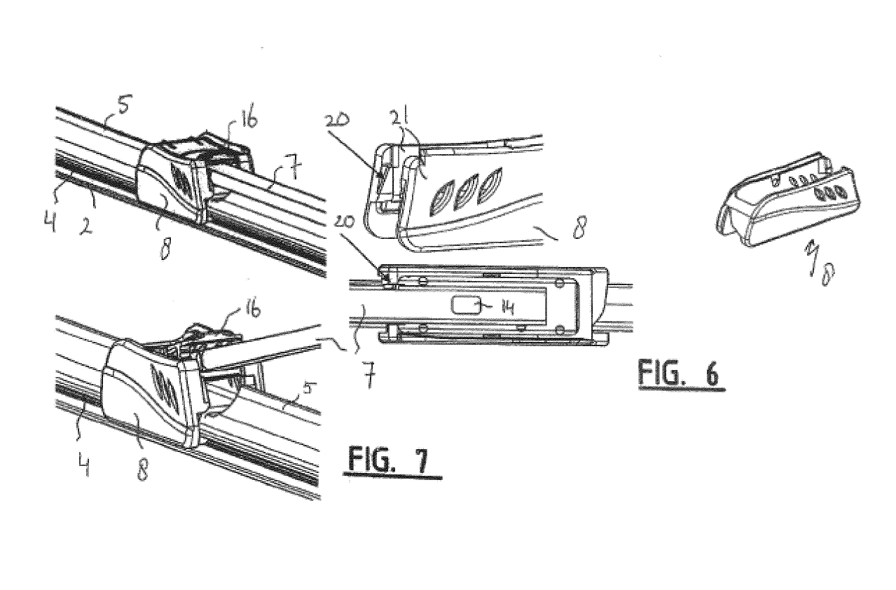

Referring to FIGS. 1, 2, 3 and 5, the second part 9 comprises a protrusion 13 extending downwardly from a top wall of the second part 9, while the oscillating arm 7 has an identically shaped hole 14 with a closed circumference at the location of its connection to the second part 9. the protrusion is hingeable between an inward position (FIG. 2 above and FIG. 5 above), wherein in a mounted position the protrusion 13 engages into the hole 14 provided in the oscillating arm 7 in order to retain the connecting device 6 onto the oscillating aria 7, and an outward position (FIG. 2 below and FIG. 5 below), wherein in a dismounted position the protrusion 13 disengages from the hole 14 provided in the oscillating arm 7, allowing the connecting device 6 to be released from the oscillating arm 3. As shown, the protrusion 13 is hingeable along two lateral hinges 15 located near an outer edge of the second part 9 and on opposite sides of the oscillating arm 7, upon activating a push button 16 on the second part 9 by hand in the direction of arrow 17. More in particular, a part 18 of the top wall of the second part 9 is hingeable about the hinges 15, wherein the push button 16 is located at a top side of the part 18 near one end thereof, and wherein the protrusion 13 is located at a bottom side of the part 18 near an opposite end thereof. By activating or deactivating the push button 16, a hinge movement in the direction of arrows 19 is obtained. The movement is a so-called seesaw movement. the hinges 15 are invisible from the outside when the first and second parts 8,9 are interconnected.

The protrusion 13 on the second part 9 and the hole 14 in the oscillating arm 7 are meant for retaining the connecting device 6 onto the oscillating aria 7 and are therefore called “first retaining means”. However, in case the first retaining means would disfunction, for example when the protrusion 13 would not properly fit into the hole 14, the second part 9 and the first part 8 connected thereto would be able to move relative to the oscillating arm 7 in longitudinal direction of the wiper blade 2. In order to avoid the wiper blade 2 from coming loose, with all negative consequences involved, second retaining means are provided for. the second retaining means consist of an upwardly extending protrusion 20 on at least one of the parallel, upright walls 21 of the first part 8 cooperating with a recess 22 in the oscillating arm 7 (FIG. 1). In other words, the protrusion 20 engages into the correspondingly shaped recess 22 provided on a longitudinal (exterior) side 23 of the oscillating arm 7. the protrusion 20 may also be called a cam.

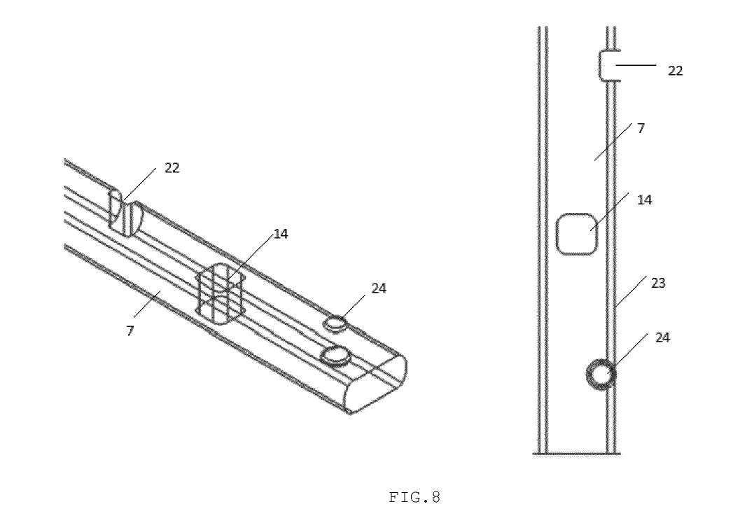

For mounting or dismounting the connecting device 6 onto or from the oscillating arm 7, the second part 9 and thus the free end of the oscillating arm 7 connected thereto is pivoted relative to the first part 8 (FIG. 7). While carrying out the pivot movement the protrusion or cam 20 is no longer in line with the recess 22 and cannot mutually cooperate any longer, so that the second part 9 and the first part 8 attached thereto can be released from the oscillating arm 7. This can, of course, only be done when also the protrusion 13 in all embodiments is released from the hole 14.

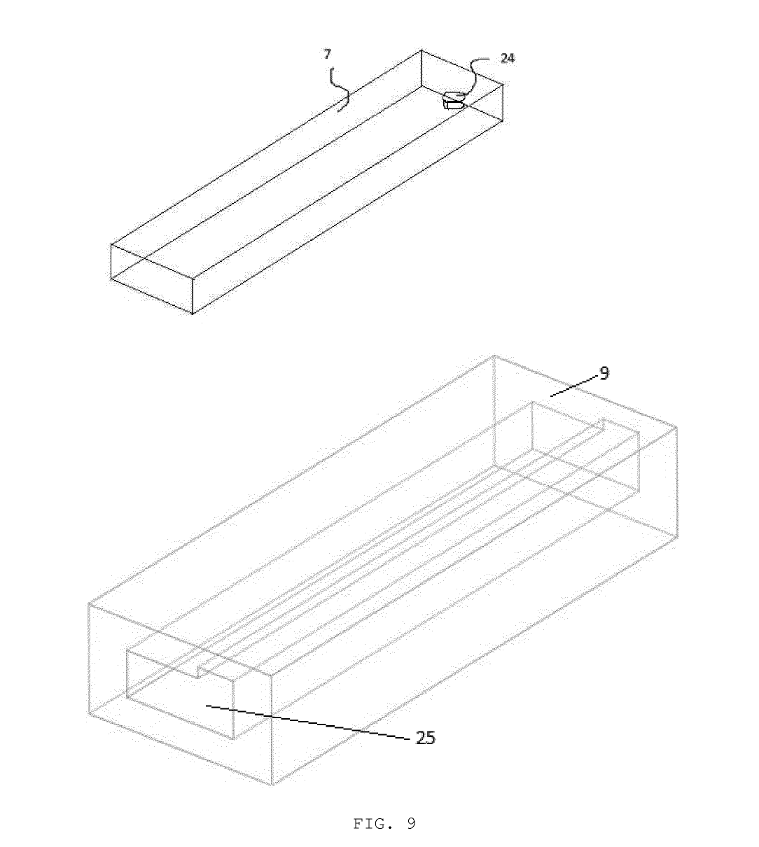

In a vehicle provided with at least two windscreen wiper devices of the flat blade type (one at the driver's side and the other at the passenger's side) an asymmetric form of the second part 9 and of the extension of the oscillating arm 7 with respect to their middle longitudinal planes, seen in vertical direction, is obtained. Reference is made to FIG. 9. Indeed, the extension is provided with a protuberance 24 extending upwardly from a top surface of the extension and the channel is provided with a correspondingly shaped groove 25. Due to this asymmetric form of both the second part 9 and its corresponding oscillating arm 7 it ensured that each windscreen wiper device 1 can only be mounted on its corresponding oscillating arm 7. Hence, it is prevented that the windscreen wiper device 1 meant for the oscillating arm 7 at the passenger side of the automobile can be mounted on the oscillating arm 7 at the driver's side of the automobile, and that the windscreen wiper device 1 meant for the oscillating arm 7 at the driver's side of the automobile can be mounted on the oscillating arm at the passenger's side of the automobile.

The invention is not restricted to the variants shown in the drawing, but it also extends to other embodiments that fall within the scope of the appended claims.

1. A vehicle provided with at least two windscreen wiper devices of the flat blade type each comprising an elastic, elongated carrier element, as well as an elongated wiper blade of a flexible material, which can be placed in abutment with a windscreen of the vehicle to be wiped, each wiper blade including at least one groove, in which groove a longitudinal strip of the carrier element is disposed, which windscreen wiper devices each comprise a connecting device for a respective oscillating arm, wherein each oscillating arm is pivotally connected to its corresponding connecting device about a pivot axis near one end, wherein each connecting device comprises at least two parts provided with protrusion/hole features arranged for connecting said parts together through a snapping operation, wherein the first part is retained onto its corresponding wiper blade and wherein the second part comprises a channel arranged for inserting a rod-like extension of its corresponding oscillating arm therein, and wherein each second part and said extension of its corresponding oscillating arm comprise mutually cooperating protuberance/groove features resulting in an asymmetric form of said second part and of said extension of said oscillating arm with respect to their middle longitudinal planes, seen in vertical direction, in order to ensure that each windscreen wiper device can only be mounted on its corresponding oscillating arm.

2. The vehicle according to claim 1, wherein said extension is provided with a protuberance cooperating with a groove of said channel.

3. The vehicle according to claim 1, wherein said channel and said extension each have a rectangular cross-section.

4. A vehicle according to claim 2, wherein said protuberance extends upwardly from an upper surface of said extension, and wherein said groove extends in an upper wall of said channel.

5. A vehicle according to claim 1, wherein each windscreen wiper device is provided with retaining structure arranged for retaining said connecting device onto said extension of its corresponding oscillating arm, wherein said retaining structure comprises at least one downwardly extending protrusion on the second part, wherein said protrusion is movable between an inward position, wherein in mounted position said protrusion engages into a correspondingly shaped hole provided in said extension of said oscillating arm and said connecting device is retained onto said oscillating arm, and an outward position, wherein in dismounted position said protrusion disengages from said hole provided in said extension of said oscillating arm and said connecting device is released from said oscillating arm.

6. A vehicle according to claim 5, wherein upon activating a push button on said second part said protrusion is hingeable from said inward position and said outward position along hinges of said second part located on opposite sides of said extension of said oscillating arm in mounted position thereof.

7. A vehicle according to claim 5, wherein said retaining structure form first retaining feature, and wherein each windscreen wiper device further comprises second retaining feature arranged for retaining said connecting device onto said extension of its corresponding oscillating arm, wherein said second retaining feature comprises at least one protrusion provided on the first part arranged to engage into a recess provided along a longitudinal side of the extension of the oscillating arm.

8-9. (canceled)
